(19) United States
(12) Patent Application Publication
(10) Pub. No.: US 2023/0244346 A1
(43) Pub. Date: Aug. 3, 2023

(54) WINDOW-DISPLAY

(71) Applicant: Stanley Reznik, Brooklyn, NY (US)

(72) Inventor: Boris Viktorovich Myznikov, Moscow (IT)

(21) Appl. No.: 18/015,414

(22) PCT Filed: Jan. 21, 2021
(86) PCT No.: PCT/RU2021/050014

§ 371 Date: Jan. 10, 2023

(30) Foreign Application Priority Data
Jul. 11, 2020 (RU) 2020123057

(51) Int. Cl. G06F 3/042; G06F 3/01; H04N 13/239; H04N 13/366

(52) U.S. Cl. CPC G06F 3/042; G06F 3/012; G06F 3/013; H04N 13/239; H04N 13/366

(57) ABSTRACT

The invention relates to a window that simultaneously is a display. The window-display comprising: a frame encasing a double-glazed window made of a transparent material, where the double-glazed window comprises a layer that is a transparent display connected to the module for displaying an image on the said display. According to the invention, the module for displaying an image on the display is connected to the module for determining the location of the user's eyes in the room and is configured to recalculate the image depending on the location of the user's eyes. The achieved technical result is the expansion of the functionality of the window, namely the ability to use it as an image display device in the form of augmented reality, which adjusts to the user's location.

### THE FIELD OF TECHNOLOGY TO WHICH THE INVENTION RELATES

The invention relates to a window that simultaneously is a display. The window-display comprising: a frame encasing a double-glazed window made of a transparent material, where the double-glazed window comprises a layer that is a transparent display connected to the module for displaying an image on the said display. The achieved technical result is the ability to use the image display device in the form of augmented reality, which adjusts to the user's location.

### THE LEVEL OF TECHNOLOGY

Currently, the combination of functions in one device is becoming increasingly common. So the window can be used to display an image, which allows not only to abandon the use of TVs, but also expands the capabilities of the window itself. For example, it allows you to change the panorama outside the window using the window in the “virtual window” mode or display various data in the background, quotes, time, temperature, and running news feed.

So it is known from the prior to have a window-display, consisting of a frame encasing a double-glazed window made of a transparent material, while the double-glazed window includes a layer that is a transparent display connected to an image output module on the display.

Such devices are described on the Internet:

https://zen.yandex.ru/media/oknoved/legkim-kasaniem-ruki-okno-prevrascaetsia-v-planshet-5d64cc34a660d700ad2c417e

https://www.oknamedia.ru/novosti/sensornye-okna-zamenyat-plastikovye-46863

https://tybet.ru/content/news/index.php?SECTION_ID=604&ELEMENT_ID=86987

These devices are the closest in technical essence and achieved technical results. They are chosen as a prototype of the proposed invention as a device.

The disadvantage of any of these prototypes is that there is no rearrangement of the image depending on the user's point of view, which does not allow to realize the effect of being in virtual reality. In particular, it is not possible to ensure that the image is rearranged depending on the location of the user's head. That is, if you display an image on top of what is actually seen, then it will immediately be clear where which image is, there is no “presence effect” when virtual objects are perceived as real.

Also, the user cannot remotely manipulate virtual objects with the help of hands, which is necessary, for example, in the educational or gaming process, as well as to control the device.

### DISCLOSURE OF THE INVENTION

The present invention mainly aims to offer the window-display including a frame encasing a double-glazed window made of transparent material, while the double-glazed window includes a layer that is a transparent display connected to an image output module on the specified display, allowing at least to smooth out at least one of the above disadvantages, namely: to provide the ability to use it as an image output device in the form of augmented reality, which adapts to the user's location, which gives an additional effect of presence and is a solution for the task in hand.

To achieve this goal, the display image output module is connected to the user's body parts detection module in the room and is configured to recalculate the image depending on the location of the user's body parts.

With these advantageous characteristics, it becomes possible to recalculate the displayed image depending on the location of the user's body parts.

There is a variant of the invention, in which the module for detecting the location of body parts of the user's body in the room is configured to determine the location of the user's eyes.

Due to these advantageous characteristics, it is possible to accurately recalculate the displayed image, changing it in accordance with the user's point of view in the virtual space for the left and right eye at the same time.

There is a variant of the invention, in which the module for determining the location of the body parts of the user in the room is configured to determine the location of the user's hands.

Thanks to these advantageous characteristics, it becomes possible to accurately recalculate the displayed image, adjusting it to the position of the user's hands, which makes it possible to control the device from a distance, as well as broadcast virtual objects that the user can control—change their position, rotate, move.

There is also such a variant of the invention, in which the module for determining the location of the user in the room is made in the form of at least one video camera.

Thanks to these advantageous characteristics, it becomes possible to determine the location of the user from images obtained from a video camera in the visible or infrared spectrum. There is also such a variant of the invention, in which the block for determining the position of the user includes a module for determining the position of sensors attached to the user.

There is also such a variant of the invention, in which the module for determining the location of the user in the room is made in the form of a stereo pair of two video cameras.

Thanks to this advantageous characteristic, it becomes possible to increase the accuracy of determining the position of the user and his/her individual parts (head, hands), due to the presence of a stereo pair, which allows you to build an accurate spatial scene.

There is, among other things, a variant of the invention, in which the module for determining the location of the user in the room is connected to the module for selecting from a plurality of certain body parts of a plurality of users of one.

Thanks to this advantageous characteristic, it becomes possible to automatically select one from many users. This can be the closest user (since the effect of augmented reality decreases with distance), or the user located in the center of a group of users (then the total distortion for the rest decreases).

There is a variant of the invention, in which the module for displaying an image on the display is configured to recalculate the perspective of the image in virtual space depending on the coordinates and direction of inclination and/or rotation of the user's head in three-dimensional space to create the user's illusion of free movement in virtual space.

With this advantageous characteristic, it becomes possible to take into account the direction of tilt and/or rotation of the user's head to display an image. That is, the image takes into account the direction of inclination and/or rotation of the user's head, including its coordinates in three dimensions x and angles of inclination, rotation along three mutually perpendicular axes, which gives an additional effect of presence. From any tilt, rotation, or movement of the head, the image is rebuilt, reflecting a change in point of view in virtual space.

Finally, there is a variant of the invention, in which the display module is connected to the module for determining the location of the user touching the insulating glass unit.

Thanks to this advantageous characteristic, it becomes possible to additionally control the device by touching the glass unit itself (touch input).

### BRIEF DESCRIPTION OF THE DRAWINGS

Other features and advantages of the invention will clearly appear from the description which follows, by way of illustration and without being restrictive, with reference to the accompanying drawings wherein:

FIG. 1 schematically depicts a functional diagram of a window-display according to the invention;

FIGS. 2 and 3 schematically depict different options for displaying images depending on the position of the user, according to the invention, front view;

FIG. 4 schematically depicts the stages of operation of the window-display according to the invention.

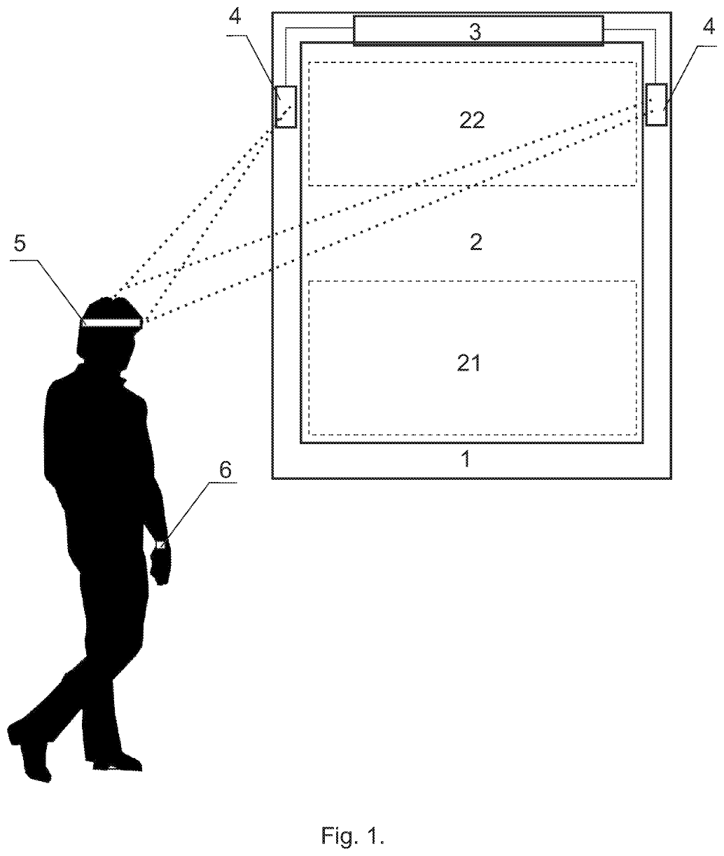

According to FIGS. 1-3, the window-display includes a frame 1 encasing a double-glazed window 2 made of a transparent material. Wherein, the double-glazed window 2 includes a layer that is a transparent display connected to module 3 for displaying an image on the specified display. Module 3 for outputting an image to the display is connected to module 4 for determining the location of the user's body parts in the room and is configured to recalculate the image depending on the location of the user's body.

Module 4 for determining the location of the user's body parts in the room can be configured to determine the location of the user's eyes 5 and/or the location of the user's hands 6. (Shown conditionally in FIG. 1).

Module 4 for determining the location of the user in the room can be made in the form of at least one video camera or a stereo pair of two video cameras. (See FIG. 1).

The indoor user location module 4 may be configured to select from a plurality of specific body parts of a plurality of users alone.

Different algorithms can be used for this:
selection of the closest user,
selection of an arbitrary specific user,
the choice of the user who is located in the geometric center of the set of users, that is, who has the minimum total distance to all other users,
alternate switching between users.

Neural network algorithms can be used, which remember the choice and then automatically selects the optimal mode of operation. To do this, the device can remember the rating of its work, which the user assigns to it. For example, when a bad match of the displayed image is detected, a voice command is made, which is entered into the device database.

The display module 3 can be configured to recalculate the perspective of the image in virtual space depending on the coordinates and direction of inclination and/or rotation of the user's head in three-dimensional space to create the user's illusion of free movement in virtual space.

Module 3 displaying the image on the display can be connected to the module for determining the location of the touch of the insulating glass unit by the user. Not shown in the figure. This is touch-screen technology—determining the location of the touch screen.

Module 4 for determining the location of the user in the room can be made in the form of a mono or stereo video camera operating in the visible or infrared range. An example of such an implementation is Kinect, see for example https://wikipedia.org/wiki/Kinect

Not only video cameras can be used to determine the location of the user's body parts, but also technologies such as:
Infrared positioning. A mobile tag in an infrared positioning system emits infrared pulses that are received by system receivers that have fixed coordinates. The location of the tag is calculated by Time-of-flight (ToF)—the time of signal propagation from the source to the receiver. The disadvantage of the method is the sensitivity to interference from sunlight. The use of an IR laser increases the range and accuracy. The positioning accuracy of this method is 10-30 centimeters.
Ultrasonic positioning. Ultrasonic positioning systems use frequencies from 40-130 kHz. To determine the coordinates of the tag, the ToF of up to four receivers is usually measured. The main disadvantage is the sensitivity to signal loss in the presence (appearance) of even “light” obstacles, to false echoes, and interference from ultrasound sources, for example, from ultrasonic flaw detectors, ultrasonic cleaners in production, and ultrasound in a hospital. To eliminate these shortcomings, it is required to carefully plan the system. The advantage of ultrasonic systems is the highest positioning accuracy, reaching three centimeters.

In addition, the device may be equipped with a speaker for transmitting sounds and a microphone for receiving voice commands.

### IMPLEMENTATION OF THE INVENTION

The window-display works as follows, see FIG. 4.

Stage A1. The user falls into the zone of visibility of module 4 for determining the location of parts of the user's body in the room.

Stage A2. The display output module 3 outputs an image to an area conventionally shown as 22, such as mountains or flying birds. At the same time, in the zone conditionally shown as 22, the user usually sees an image of what is outside the window, for example, houses or trees.

Stage A3. When the user position changes or the position of the user's head is changing, module 4 for determining the location of parts of the user's body in the room determines the position of the user's head and eyes, including coordinates and angles of inclination, rotation along three mutually perpendicular axes, and module 3 for displaying the image on the display changes the image in field 22 depending on the above, creating the effect of presence. For example, the user can view virtual objects that are “nearby” from different sides. Alternatively, this can be used to display information (video, text, etc.) exactly in the area of the window where the contrast is highest.

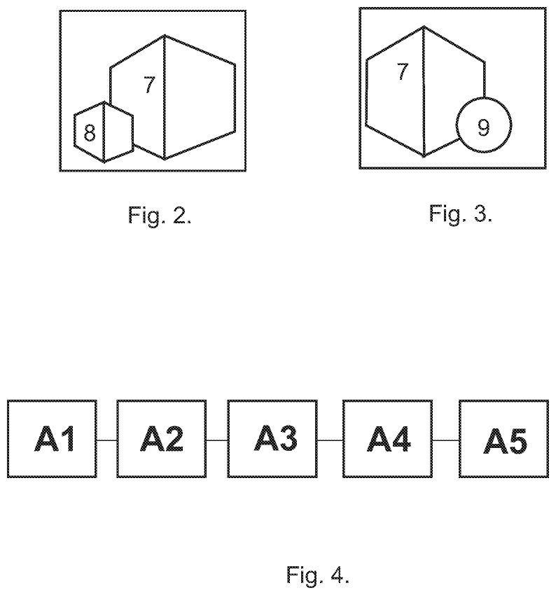

FIGS. 2 and 3 show how the virtual image displayed varies depending on the position of the user. Where is, FIG. 2 shows schematically what image is displayed on the screen when the user comes to the left of the window, particularly the main virtual object 7 and the virtual object 8 located to its left. FIG. 3 shows schematically what image is displayed on the screen when the user comes to the right of the window and sees other virtual objects, particularly the main virtual object 7 and the virtual object 9 located to the right of it.

Stage A4. Optionally, the user can control the image output parameters: pause, video rewind, color, contrast, brightness, change any modes, and other functions—by hand remotely. The user can also control the functions and outputs by voice.

Stage A5. Optionally, the user can control the image output parameters: pause, video rewind, color, contrast, brightness, change of any modes, and other functions—with the user's hands by touching the display.

### INDUSTRIAL APPLICABILITY

A three-dimensional display can be implemented by a specialist and such implementation provides the realization of the stated purpose, which allows us to conclude that the criterion of “industrial applicability” for the invention is met.

The proposed window-display brings forth the ability to use it as an image output device in the form of augmented reality, which adapts to the user's location.

This is due to the fact that the device will allow to produce:
1. automatic recognition of the user's position;
2. automatic recognition of the position of the head and, in particular, the eyes of the user;
3. automatic recognition of the position of the user's hands;
4. automatic recalculation of the image displayed on the screen, depending on the received user coordinates.

The present invention can be used as:
1. Devices for displaying any images of augmented reality to create user comfort.
2. Devices for displaying any information, the output of which adapts to the user's location, for example, is displayed in the most contrasting area in the field of view.
3. Devices for managing the displayed information are not distant.
4. Devices for indoor sports in conjunction with simulators, in which the image outside the window changes depending on the conditionally traveled distance.
5. Devices in which a virtual interlocutor can follow the user's eyes, tracking his location, creating a “real dialogue effect”.

Thus, it is possible to utilize a window-display that implements the full effect of presence by displaying augmented reality objects on it adapting to the user's location and also respond to user's actions. The window-display in the dimming mode completely replaces a conventional TV, in the display deactivation mode it becomes a simple window. In the operating mode, it can be a combined option that displays dark letters on a light background, for example, the sky, as it is visible to the user, or light letters on the dark background of real objects, as they are visible from the user's side. The same goes for the image.

This way you can achieve the effect of complete immersion of being in another climatic zone, another geographical location, and even another planet.

What is claimed is:

1. A window-display comprising:
a frame encasing a double-glazed window made of a transparent material, where the double-glazed window comprises a layer that is a transparent display connected to the module for displaying an image on the said display;
wherein the module for outputting an image to the display is connected to the module for determining the location of parts of the user's body in the room and is configured to recalculate the image depending on the location of the user's body parts.

2. The window-display of claim 1, wherein it has the module for determining the location of the user's body parts in the room, and is configured with the ability to locate the user's eyes.

3. The window-display of claim 1, wherein it has the module for determining the location of the user's body parts in the room and is configured with the ability to determine the location of the user's hands.

4. The window-display of claim 1, wherein it has the module for determining the user's location in the room made in the form of at least one video camera.

5. The window-display of claim 1, wherein it has the module for determining the user's location in the room made in the form of a stereo pair of two video cameras.

6. The window-display of claim 1, wherein it has the module for determining the location of the user in the room can be configured to select from a plurality of specific body parts of a plurality of users to one.

7. The window-display of claim 2, wherein it has the module for displaying an image on the display is configured to recalculate the perspective of the image in virtual space depending on the coordinates and direction of inclination and/or rotation of the user's head in three-dimensional space to create the user's illusion of free movement in virtual space.

8. The window-display of claim 2, wherein it has the module for displaying the image on the display is connected to the module for determining the location of the touch of the double-glazed window by the user.
